(19) United States
(12) Patent Application Publication
(10) Pub. No.: US 2008/0215597 A1
(43) Pub. Date: Sep. 4, 2008

(54) Information processing apparatus, information processing system, and program

(76) Inventor: Hidetsugu Nanba, Hiroshima (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 11/368,610

(22) Filed: Mar. 7, 2006

(30) Foreign Application Priority Data
Jun. 21, 2005 (JP) 2005-180435

(51) Int. Cl. G06F 17/30

(52) U.S. Cl. 707/100; 707/E17.001

(57) ABSTRACT

Conventional information processing apparatuses have a problem that the precision of related term collection is low. An information processing apparatus is provided which comprises a document information storing section for storing one or more pieces of document information, a term information receiving section for receiving term information, a document information obtaining section for obtaining the whole or a part of document information having the term information, a cited document information obtaining section for obtaining the whole or a part of cited document information which is information of a cited document having a citation relationship with a document corresponding to the document information, from the document information storing section, based on the whole or the part of the document information obtained by the document information obtaining section, a related term information obtaining section for obtaining related term information which is information of a related term which is related to the term indicated by the term information, based on the whole or the part of the cited document information obtained by the cited document information obtaining section, and a related term information outputting section for outputting the related term information obtained by the related term information obtaining section. Thereby, the precision of related term collection can be improved.

### BACKGROUND OF THE INVENTION

1. Field of the Invention

The present invention relates to an information processing apparatus or the like which collects related terms.

2. Description of the Related Art

Conventionally, information processing apparatuses for automatically searching Web sites to collect related terms have been developed (see, for example, Non-patent Document 1, Non-patent Document 2, Non-patent Document 3, and Non-patent Document 4). In general, collection of terms related to a certain technical term t from the Web requires a procedure of initially collecting descriptions related to the term t and thereafter extracting terms related to t from the collected descriptions. Here, an important point is how to collect appropriate descriptions related to the term t. For example, in Non-patent Document 1, descriptions related to the term t are collected using the following method. Concerning the term t, four queries, “what is t”, “called t”, “t is”, and “t”, are input into a search engine, and top 100 URLs are obtained for each query. Next, the obtained web sites are formatted and divided into sentences, only sentences containing the term t are extracted, and terms related to the term .t are collected from the extracted sentences in the conventional art.

Note that there is a system to support writing a survey, considering reference information between papers (Non-patent Document 5).

[Non-patent Document 1] Satoshi Sato and another author, “Automatic Collection of Related Terms from the Web”, Information Processing Society of Japan, SIG Technical Reports, Natural language processing, (2003), NL-153, pp. 57-64

[Non-patent Document 2] Yasuhiro Sasaki and two other -authors, “Proposal of Indicator for Measuring Relevance between Terms”, 10th Annual Meeting of The Association for Natural Language, (2004), pp. 25-28

[Non-patent Document 3] Kiyoaki Shirai and three other authors, “Attempt to Automatically Constructing a Portal Site”, 10th Annual Meeting of The Association for Natural Language, (2004), pp. 624-627

[Non-patent Document 4] Kyosuke Ohara and three other authors, “Collection of Related Terms Using the Web”, Third Forum on Information Technology (FIT2004), (2004), pp. 183-184

[Non-patent Document 5] Hidetsugu Nanba and another author, “Towards Multi-paper Summarization Using Reference Information”, Journal of Natural Language Processing, (1999), Vol. 6, No. 5, pp. 43-62

However, in such conventional information processing apparatuses, no attention is paid to a citation relationship between documents, and a Web search engine is used to collect related sites for each term, and related terms are extracted from the collected sites, and therefore, it takes a long time to collect the related terms. Also in such conventional information processing apparatuses, since no attention is paid to a citation relationship between documents, collection of related terms has low precision.

### SUMMARY OF THE INVENTION

A first aspect of the present invention is directed to an information processing apparatus comprising a document information storing section for storing one or more pieces of document information which is information of a document, a term information receiving section for receiving term information which is information of a term, a document information obtaining section for obtaining the whole or a part of document information having the term information, a cited document information obtaining section for obtaining the whole or a part of cited document information which is information of a cited document having a citation relationship with a document corresponding to the document information, from the document information storing section, based on the whole or the part of the document information obtained by the document information obtaining section, a related term information obtaining section for obtaining related term information which is information of a related term which is related to the term indicated by the term information, based on the whole or the part of the cited document information obtained by the cited document information obtaining section, and a related term information outputting section for outputting the related term information obtained by the related term information obtaining section.

Thereby, it is possible to collect related terms which are related to a received term with high speed and improve the precision of related term collection.

In an information processing apparatus according to a second aspect of the present invention based on the first aspect, the related term information obtaining section comprises related term candidate information obtaining means for obtaining related term candidate information which is term information possessed by the whole or the part of the cited document information obtained by the cited document information obtaining section, relevance calculating means for calculating a relevance between the related term candidate information and the term information received by the term information receiving section, based on a frequency of appearance of the related term candidate information in the whole or a part of one or more pieces of cited document information obtained by the cited document information obtaining section, and related term information determining means for determining the related term candidate information as related term information based on the relevance.

Thereby, it is possible to collect related terms which are related to a received term with high speed and improve the precision of related term collection.

In an information processing apparatus according to a third aspect of the present invention based on the second aspect, the related term information obtaining section further comprises importance obtaining means for obtaining an importance of the related term candidate information obtained by the related term candidate information obtaining means. The relevance calculating means calculates the relevance with respect to only related term candidate information whose importance obtained by the importance obtaining means satisfies a predetermined condition.

Thereby, it is possible to further improve the precision of related term collection.

In an information processing apparatus according to a fourth aspect of the present invention based on any of the first to third aspects, the cited document information obtaining section obtains the whole or a part of cited document information of only a cited document having a predetermined citation relationship with a document indicated by the document information, from the document information storing section.

Thereby, it is possible to further improve the precision of related term collection.

In an information processing apparatus according to a fifth aspect of the present invention based on any of the first to fourth aspects, the document information storing section stores two or more types of document information, and the cited document information obtaining section obtains the whole or a part of cited document information of a cited document which has a citation relationship with a document corresponding to the document information and is of a type different from that of the document, from the document information storing section.

Thereby, it is possible to collect a broad range of related terms.

In an information processing apparatus according to a sixth aspect of the present invention based on the fifth aspect, the type of the document is academic paper and the type of the cited document is patent document, or the type of the document is patent document and the type of the cited document is academic paper.

Thereby, it is possible to collect related terms from useful documents, resulting in high-precision collection of related terms.

A seventh aspect of the present invention is directed to an information processing system comprising a server apparatus, and an information processing apparatus. The server apparatus comprises a document information storing section for storing one or more pieces of document information which is information of a document, a term information receiving section for receiving term information which is information of a term from the information processing apparatus, a document information obtaining section for obtaining the whole or a part of document information having the term information, a cited document information obtaining section for obtaining the whole or a part of cited document information which is information of a cited document having a citation relationship with a document corresponding to the document information, from the document information storing section, based on the whole or the part of the document information obtained by the document information obtaining section, a related term information obtaining section for obtaining related term information which is information of a related term which is related to the term indicated by the term information, based on the whole or the part of the cited document information obtained by the cited document information obtaining section, a processing section for performing a process based on the related term information obtained by the related term information obtaining section, and a process result transmitting section for transmitting a result of the process in the processing section to the information processing apparatus. The information processing apparatus comprises a term information receiving section for receiving term information, a term information transmitting section for transmitting the term information to the server apparatus, a process result receiving section for receiving the process result, corresponding to the transmission of the term information, and a process result outputting section for outputting the process result received by the process result receiving section.

Thereby, it is possible to collect related terms which are related to a received term with high speed and improve the precision of related term collection.

In an information processing system according to an eighth aspect of the present invention based on the seventh aspect, the related term information obtaining section comprises related term candidate information obtaining means for obtaining related term candidate information which is term information possessed by the whole or the part of the cited document information obtained by the cited document information obtaining section, relevance calculating means for calculating a relevance between the related term candidate information and the term information received by the term information receiving section, based on a frequency of appearance of the related term candidate information in the whole or a part of one or more pieces of cited document information obtained by the cited document information obtaining section, and related term information determining means for determining the related term candidate information as related term information based on the relevance.

Thereby, it is possible to collect related terms which are related to a received term with high speed and improve the precision of related term collection.

In an information processing system according to a ninth aspect of the present invention based on the eighth aspect, the related term information obtaining section further comprises importance obtaining means for obtaining an importance of the related term candidate information obtained by the related term candidate information obtaining means. The relevance calculating means calculates the relevance with respect to only related term candidate information whose importance obtained by the importance obtaining means satisfies a predetermined condition.

Thereby, it is possible to further improve the precision of related term collection.

In an information processing system according to a tenth aspect of the present invention based on any of the seventh to ninth aspects, the cited document information obtaining section obtains the whole or a part of cited document information of only a cited document having a predetermined citation relationship with a document indicated by the document information, from the document information storing section.

Thereby, it is possible to further improve the precision of related term collection.

In an information processing system according to an eleventh aspect of the present invention based on any of the seventh to tenth aspects, the document information storing section stores two or more types of document information, and the cited document information obtaining section obtains the whole or a part of cited document information of a cited document which has a citation relationship with a document corresponding to the document information and is of a type different from that of the document, from the document information storing section.

Thereby, it is possible to collect a broad range of related terms.

In an information processing system according to a twelfth aspect of the present invention based on the eleventh aspect, the type of the document is academic paper and the type of the cited document is patent document, or the type of the document is patent document and the type of the cited document is academic paper.

Thereby, it is possible to collect related terms from useful documents, resulting in high-precision collection of related terms.

Thus, according to the information processing apparatus of the present invention, it is possible to automatically obtain terms which are related to a received term.

### BRIEF DESCRIPTION OF THE DRAWINGS

FIG. 1 is a block diagram illustrating an information processing apparatus according to Embodiment 1 of the present invention.

FIG. 2 is a flowchart for explaining an operation of the information processing apparatus of Embodiment. 1.

FIG. 3 is a flowchart for explaining an operation of a document information obtaining process in Embodiment 1.

FIG. 4 is a flowchart for explaining an operation of a cited document information obtaining process in Embodiment 1.

FIG. 5 is a flowchart for explaining an operation of a related term information obtaining process in Embodiment 1.

FIG. 6 is a flowchart for explaining an operation of the information processing apparatus of Embodiment 1.

FIG. 7 is a diagram illustrating a type-C cue phrase dictionary in Embodiment 1.

FIG. 8 is a diagram illustrating a type-B cue phrase dictionary in Embodiment 1.

FIG. 9 is a diagram illustrating bibliography information obtained in Embodiment 1.

FIG. 10 is a diagram illustrating the titles of cited papers obtained in Embodiment 1.

FIG. 11 is a diagram illustrating a related term candidate information group in Embodiment 1.

FIG. 12 is a diagram illustrating evaluation value information of the related term candidate information group of Embodiment 11.

FIG. 13 is a diagram illustrating a related term information group in Embodiment 1.

FIG. 14 is a block diagram illustrating an information processing apparatus according to Embodiment 2 of the present invention.

FIG. 15 is a flowchart for explaining an operation of the information processing apparatus of Embodiment 2.

FIG. 16 is a block diagram illustrating an information processing apparatus according to Embodiment 3 of the present invention.

FIG. 17 is a flowchart for explaining an operation of a server apparatus in Embodiment 3.

### DESCRIPTION OF THE PREFERRED EMBODIMENTS

Hereinafter, an information processing apparatus and the like of the present invention will be described by way of embodiments with reference to the accompanying drawings. Parts indicated by the same reference numerals perform similar operations throughout the embodiments and may not be repeatedly described.

### EMBODIMENT 1

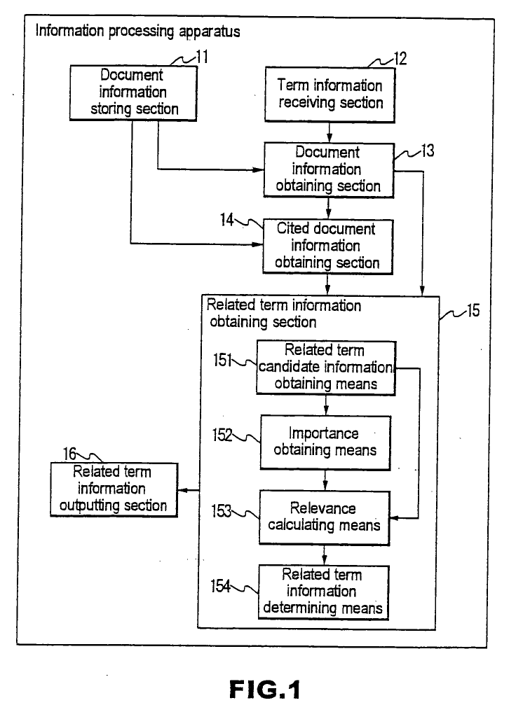

FIG. 1 is a block diagram illustrating an information processing apparatus according to Embodiment 1 of the present invention.

The information processing apparatus comprises a document information storing section 11, a term information receiving section 12, a document information obtaining section 13, a cited document information obtaining section 14, a related term information obtaining section 15, and a related term information outputting section 16.

The related term information obtaining section 15 comprises a related term candidate information obtaining means 151, an importance obtaining means 152, a relevance calculating means 153, and a related term information determining means 154.

The document information storing section 11 stores one or more pieces of document information which are each information of a document. The document information storing section 11 may store two or more types of document information. As used herein, the term “document” refers to a paper, a patent specification, a so-called Web site, or the like. The document information may not be, for example, the entire information of a patent. The document information may be, for example, only the abstract of the information of a patent. The document information storing section 11 is preferably a non-volatile recording medium, and may be implemented as a volatile recording medium. When the document information storing section 11 is a volatile recording medium, document information may be originally present in an apparatus other than the information processing apparatus.

The term information receiving section 12 receives term information which is information of a term. Any input means, such as a keyboard, a mouse, a menu screen, or the like, may be used to input the term information. The term information receiving section 12 may receive the term information from an external apparatus. The term information receiving section 12 can be implemented as a device driver for an input means, such as a keyboard or the like, software for controlling a menu screen, or the like.

The document information obtaining section 13 obtains the whole or a part of document information having the term information received by the term information receiving section 12. Apart of document information may be, for example, the title of the document information. Also, for example, when document information is patent information, a part of the document information may be information of the background art in the patent information. Also, a part of document information may be, for example, the abstract of the document information (the abstract of a paper). A part of document information which has the term information may be the same as or different from the part of the document information obtained by the document information obtaining section 13. Specifically, for example, the document information obtaining section 13 may obtain information of the title of the document information when the document information has the term information at the abstract thereof. The document information obtaining section 13 can be typically implemented using an MPU, a memory, and the like. The process procedure of the document information obtaining 10. section 13 is typically implemented by software, and the software is typically recorded in a recording medium, such as a ROM or the like. Note that the process procedure of the document information obtaining section 13 may be implemented by hardware (dedicated circuit).

Based on the whole or the part of the document information obtained by the document information obtaining section 13, the cited document information obtaining section 14 obtains the whole or a part of cited document information which is information of a cited document having a citation relationship with a document corresponding to the document information, from the document information storing section 11. Preferably, the cited document information obtaining section 14 obtains the whole or a part of cited document information of only a cited document having a predetermined citation relationship with the document indicating the document information, from the document information storing section 11. As used herein, the term “predetermined citation relationship” refers to a problem-pointing type citation relationship (“type C” below) in which one document points out a problem with a theory, a method, or the like of the other document, a basis-of-theory type citation relationship (“type B” below) in which one document proposes a new theory or constructs a system based on the result of study in the other document. Note that a specific algorithm example in which the cited document information obtaining section 14 obtains cited document information of a cited document having a citation relationship, and a specific algorithm example in which the cited document information obtaining section 14 obtains cited document information of a cited document having a predetermined citation relationship, will be described below. The cited document information obtaining section 14 may obtain the whole or a part of cited document information of a cited document which has a citation relationship with a document corresponding to the document information but is of a type different from that of the document corresponding to the document information, from the document information storing section 11. The cited document information obtaining section 14 may be typically implemented using an MPU, a memory, and the like. The process procedure of the cited document information obtaining section 14 is typically implemented by software, and the software is typically recorded in a recording medium, such as a ROM or the like. Note that the process procedure of the cited document information obtaining section 14 may be implemented by hardware (dedicated circuit).

Based on the whole or the part of the cited document information obtained by the cited document information obtaining section 14, the related term information obtaining section 15 obtains related term information which is information of a related term which is related to the term indicated by the term information. The related term information obtaining section 15 obtains technical term information which is information indicating a technical term, from, for example, the title of cited document information obtained by the cited document information obtaining section 14. The related term information obtaining section 15 regards the technical term information as related term information. Note that the technique of obtaining technical term information from the title of a document is known and will not be described in detail. Preferably, the related term information obtaining section 15 obtains related term information by processes of the related term candidate information obtaining means 151, the importance obtaining means 152, the relevance calculating means 153, and the related term information determining means 154 as described below. In addition, the algorithm which causes the related term information obtaining section 15 to obtain related term information is not particularly limited. An example of the algorithm will be described below. The related term information obtaining section 15 can be typically implemented using an MPU, a memory, and the like. The process procedure of the related term information obtaining section 15 is typically implemented by software, and the software is typically recorded in a recording medium, such as a ROM or the like. Note that the process procedure of the related term information obtaining section 15 may be implemented by hardware (dedicated circuit).

The related term candidate information obtaining means 151 obtains related term candidate information which is term information possessed by the whole or the part of the cited document information obtained by the cited document information obtaining section 14. The related term candidate information obtaining means 151 obtains technical term information which is information indicating technical term, from, for example, the title of cited document information obtained by the cited document information obtaining section 14. The related term candidate information obtaining means 151 regards the technical term information as related term candidate information.

The importance obtaining means 152 obtains the importance of the related term candidate information obtained by the related term candidate information obtaining means 151. Note that the process of the importance obtaining means 152 obtaining the importance is a known technique and will not be described in detail. The importance obtaining means 152 may obtain an importance based on, for example, a rule that “a compound word which contains a noun which can adjoin a number of different words has a high importance”. For example, the importance obtaining means 152 may obtain a frequency of appearance of related term candidate information in the whole or a part (e.g., a title, an abstract, etc.) of document information in the document information storing section 11, and uses the frequency of appearance as a parameter to obtain the importance of the related term candidate information. Note that, typically, the higher the frequency of appearance, the higher the importance.

The relevance calculating means 153 calculates a relevance between the related term candidate information and the term information received by the term information receiving section 12, based on the frequency of appearance of the related term candidate information in the whole or a part of one or more pieces of cited document information obtained by the cited document information obtaining section 14. Preferably, the relevance calculating means 153 calculates a relevance with respect to only related term candidate information whose importance obtained by the importance obtaining means 152 satisfies a predetermined condition. The process of the relevance calculating means 153 is a known technique and will not be described in detail. Note that the relevance calculating means 153 may calculate the relevance based on the frequency of the related term candidate information appearing in the titles of all pieces of obtained cited document information.

Based on the relevance obtained by the relevance calculating means 153, the related term information determining means 154 determines related term candidate information as related term information. For example, the related term information determining means 154 determines, as related term information, related term candidate information which has a predetermined relevance or more (a high relevance).

The related term candidate information obtaining means 151, the importance obtaining means 152, the relevance calculating means 153, and the related term information determining means 154 can be typically implemented using an MPU, a memory, and the like. The process procedures of the related term candidate information obtaining means 151, the importance obtaining means 152, the relevance calculating means 153, and the related term information determining means 154 are typically implemented by software, and the software is typically recorded in a recording medium, such as a ROM or the like. Note that these process procedures may be implemented by hardware (dedicated circuit).

The related term information outputting section 16 outputs the related term information obtained by the related term information obtaining section 15. Here, the term “output” has a concept including displaying on a display screen, accumulation into a recording medium, printing in a printer, outputting a sound, transmission to an external apparatus, and the like. When the outputting is accumulation into a recording medium, the information processing apparatus is an apparatus which automatically constructs a related term dictionary. The related term information outputting section 16 may or may not include an output device, such as a display, a loudspeaker, or the like. The related term information outputting section 16 can be implemented as driver software for an output device, a combination of driver software for an output device and the output device, or the like.

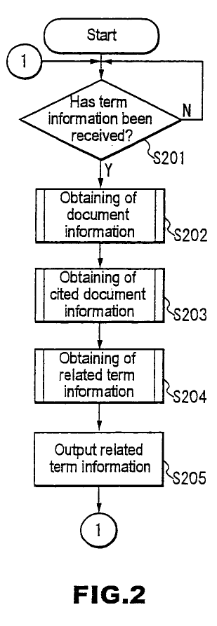

Next, an operation of the information processing apparatus will be described with reference to flowcharts illustrated in FIGS. 2 to 6.

(Step S201) The term information receiving section 12 determines whether or not it has received term information. The term information receiving section 12 goes to step S202 when having received term information, and returns to step S201 when not having received term information.

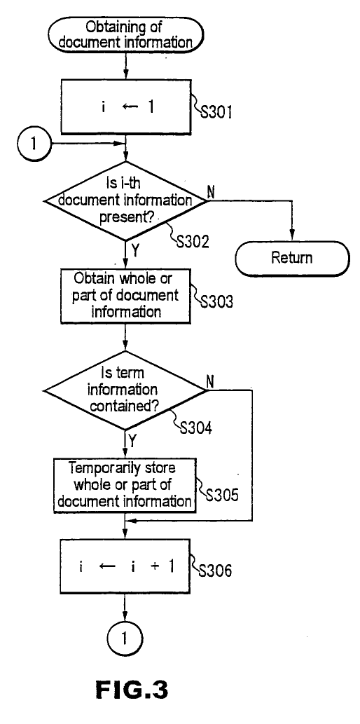

(Step S202) The document information obtaining section 13 obtains the whole or a part of document information having the term information received by the term information receiving section 12, from the document information storing section 11. For example, the document information obtaining section 13 obtains the whole or a part of document information having the term information received by the term information receiving section 12 in a section thereof, such as the title, the abstract, or the like. A part of document information which is checked as to whether or not it contains the term information may be the same as or different from the part of the document information obtained by the document information obtaining section 13. The process of the document information obtaining section 13 obtaining the whole or a part of document information will be described with reference to the flowchart of FIG. 3.

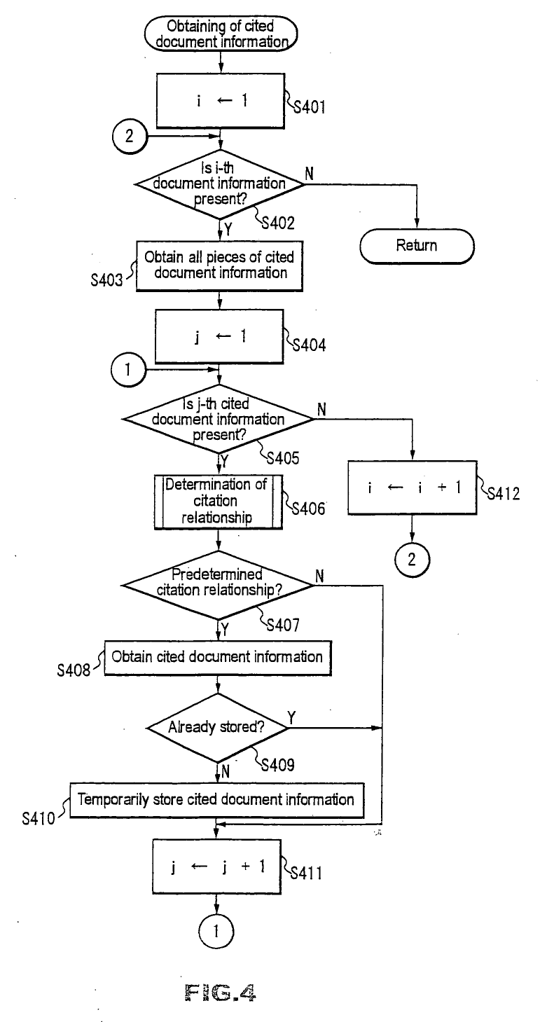

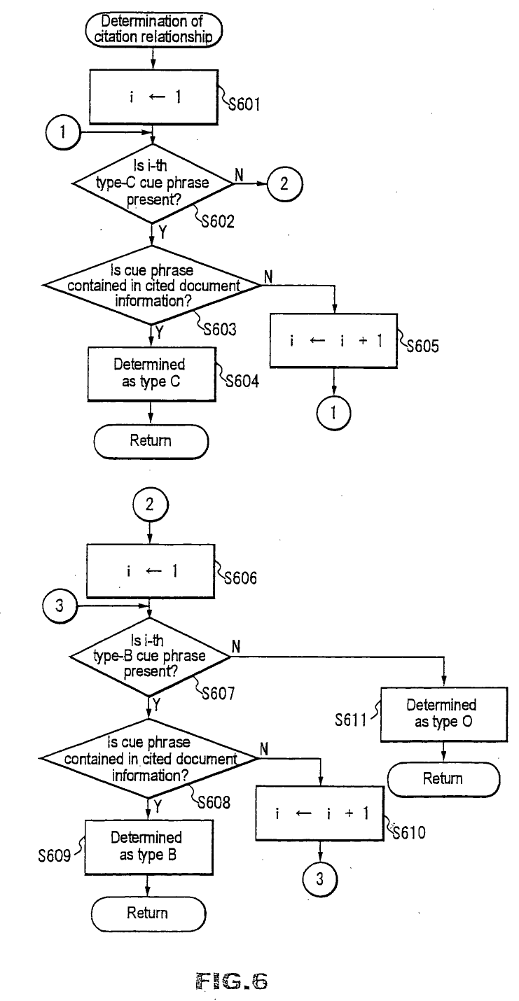

(Step S203) Based on the whole or the part of the document information obtained in step S202, the cited document information obtaining section 14 obtains the whole or a part of cited document information which is information of a cited document having a citation relationship with a document corresponding to the document information, from the document information storing section 11. The process of the cited document information obtaining section 14 obtaining the whole or a part of cited document information will be described with reference to the flowcharts of FIGS. 4 and 6.

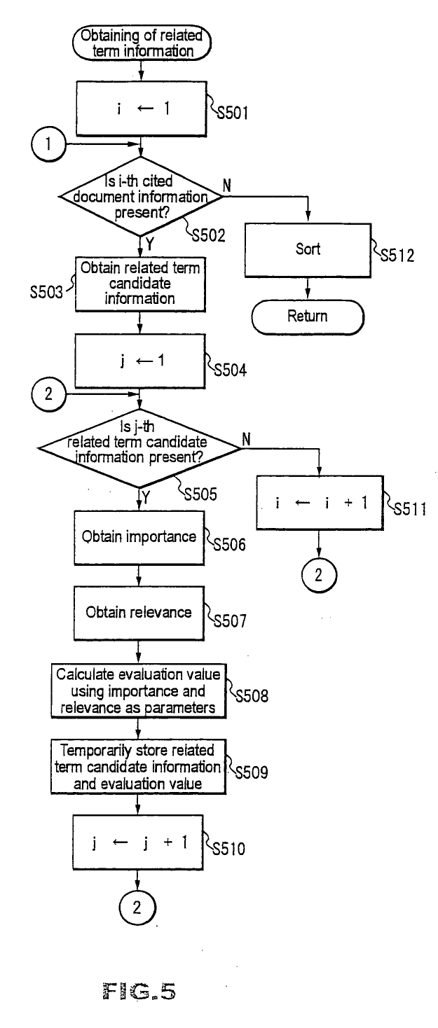

(Step S204) Based on the whole or the part of the cited document information obtained in step S203, the related term information obtaining section 15 obtains related term information. The process of the related term information obtaining section 15 obtaining the related term information will be described with reference to the flowchart of FIG. 5.

(Step S205) The related term information outputting section 16 outputs the related term information obtained in step S204. The process returns to step S201.

Note that the process is ended by powering off or interruption for aborting the process in the flowchart of FIG. 2.

Next, the document information obtaining process in step S202 will be described with reference to the flowchart of FIG. 3.

(Step S301) The document information obtaining section 13 substitutes 1 into a counter i.

(Step S302) The document information obtaining section 13 determines whether or not i-th document information is present in the document information storing section 11. If the i-th document information is present, the process goes to step S303. If the i-th document information is not present, the process returns to an upper-level function.

(Step S303) The document information obtaining section 13 obtains the whole or a part of the i-th document information. When the document information obtaining section 13 obtains a part of the i-th document information, the document information obtaining section 13 typically obtains information in a predetermined portion (e.g., a title, an abstract, a background art, etc.) of the document information.

(Step S304) The document information obtaining section 13 determines whether or not the whole or a part of the i-th document information obtained in step S303 contains the term information received by the term information receiving section 12. If the term information is contained, the process goes to step S305. If the term information is not contained, the process goes to step S306.

(Step S305) The document information obtaining section 13 temporarily stores the whole or a part of the i-th document information. Note that the information temporarily stored in step S305 may be the whole or the part of the information obtained in step S303.

(Step S306) The document information obtaining section 13 increments the counter i by 1. The process returns to step S302.

Next, the cited document information obtaining process of step S203 will be described with reference to the flowchart of FIG. 4.

(Step S401) The cited document information obtaining section 14 substitutes 1 into the counter i.

(Step S402) The cited document information obtaining section 14 determines whether or not the i-th document information is present in the document information obtained in the above-described document information obtaining process. If the i-th document information is present, the process goes to step S403. If the i-th document information is not present, the process returns to an upper-level function.

(Step S403) The cited document information obtaining section 14 obtains the whole or a part of cited document information which is information of a cited document having a citation relationship with a document cited in the i-th document information, from the document information storing section 11. Here, the cited document information obtaining section 14 obtains all pieces of cited document information cited in the i-th document information. The cited document information obtaining section 14 may obtain bibliography information of cited document information from a “Reference” section possessed by the i-th document information, and based on the bibliography information, obtain the whole or a part of the cited document information. The cited document information obtaining section 14 may also obtain bibliography information of cited document information from a “Background art” or “Related achievements” section possessed by the i-th document information, and based on the bibliography information, obtain the whole or a part of the cited document information. When the i-th document information is patent information (information of the specification of a patent), the cited document information obtaining section 14 may obtain bibliography information corresponding to a tag of “Patent document” or “Non-patent Document” present in the “background art” section, and based on the bibliography information, obtain the whole or a part of the cited document information. Also, when the i-th document information is information of an academic paper or a technical paper, the cited document information obtaining section 14 obtains bibliography information of other paper(s) from a “Related achievements” section possessed by the i-th document information or the entirety thereof, and based on the bibliography information, obtain the whole or a part of the cited document information.

(Step S404) The cited document information obtaining section 14 substitutes 1 into a counter j.

(Step S405) The cited document information obtaining section 14 determines whether or not j-th cited document information is present in the cited document information obtained in step S403. If the j-th cited document information is present, the process goes to step S406. If the j-th cited document information is not present, the process goes to step S412.

(Step S406) The cited document information obtaining section 14 determines a citation relationship between a document indicated by the i-th document information and a document indicated by the j-th cited document information. The process of determining a citation relationship will be described with reference to the flowchart of FIG. 6.

(Step S407) The cited document information obtaining section 14 determines whether or not the citation relationship determined in step S406 is a predetermined citation relationship. If the citation relationship determined in step S406 is the predetermined citation relationship, the process goes to step S408. If the citation relationship determined in step S406 is not the predetermined citation relationship, the process jumps to step S411.

(Step S408) The cited document information obtaining section 14 obtains the j-th cited document information.

(Step S409) The cited document information obtaining section 14 determines whether or not the j-th cited document information has already been temporarily stored. If the j-th cited document information has already been temporarily stored, the process goes to step S411. If the j-th cited document information has not yet been temporarily stored, the process goes to step S410.

(Step S410) The cited document information obtaining section 14 temporarily stores the j-th cited document information.

(Step S411) The cited document information obtaining section 14 increments the counter j by 1. The process returns to step S405.

(Step S412) The cited document information obtaining section 14 increments the counter i by 1. The process returns to step S402.

Next, the related term information obtaining process in step S204 will be described with reference to the flowchart of FIG. 5.

(Step S501) The related term candidate information obtaining means 151 substitutes 1 into the counter i.

(Step S502) The related term candidate information obtaining means 151 determines whether or not the i-th cited document information is present in the cited document information obtained by the cited document information obtaining section 14. If the i-th cited document information is present, the process goes to step S503. If the i-th cited document information is not present, the process goes to step S512.

(Step S503) The related term candidate information obtaining means 151 obtains related term candidate information which is term information possessed by the whole or a part of the i-th cited document information. Here, the related term candidate information obtaining means 151 obtains all pieces of related term candidate information. For example, the related term candidate information obtaining means 151 obtains technical term information which is information indicating a technical term, from the title of the cited document information obtained by the cited document information obtaining section 14, and regards the technical term information as related term candidate information. Note that the technique of obtaining a technical term from a title is a known technique.

(Step S504) The importance obtaining means 152 substitutes 1 into the counter j.

(Step S505) The importance obtaining means 152 determines whether or not j-th related term candidate information is present in the related term candidate information obtained in step S503. If the j-th related term candidate information is present, the process goes to step S506. If the j-th related term candidate information is not present, the process goes to step S511.

(Step S506) The importance obtaining means 152 obtains the importance of the j-th related term candidate information.

(Step S507) The relevance calculating means 153 calculates the relevance between the j-th related term candidate information and the term information received by the term information receiving section 12.

(Step S508) The related term information determining means 154 calculates an evaluation value using the importance obtained in step S506 and the relevance obtained in step S507 as parameters.

(Step S509) The related term information determining means 154 temporarily stores the j-th related term candidate information and the evaluation value calculated in step S508 in pairs.

(Step S510) The related term information determining means 154 increments the counter j by 1. The process returns to step S505.

(Step S511) The importance obtaining means 152 increments the counter i by 1. The process returns to step S502.

(Step S512) The related term information determining means 154 sorts the temporarily stored related term candidate information using the evaluation value as a key. Thereafter, the related term information determining means 154 regards top 5 pieces of related term candidate information having highest evaluation values as related term information. The process returns to an upper-level function.

Next, the citation relationship determining process in step S406 will be described with reference to the flowchart of FIG. 6.

(Step S601) The cited document information obtaining section 14 substitutes 1 into the counter i.

(Step S602) The cited document information obtaining section 14 determines whether or not an i-th type-C cue phrase is present. Note that it is here assumed that the cited document information obtaining section 14 holds a type-C cue phrase dictionary which contains a set of type-C cue phrases. Note that a type-C citation relationship refers to a problem-pointing type citation relationship in which one document points out a problem with a theory, a method, or the like of the other document. The cue phrase includes phrases, such as “However”, “In spite of”, “Although”, “but it”, and the like, used in the case of the problem-pointing type citation relationship. If the i-th type-C cue phrase is present, the process goes to step S603. If the i-th type-C cue phrase is not present, the process goes to step S606.

(Step S603) The cited document information obtaining section 14 determines whether or not the i-th type-C cue phrase is contained in cited document information. If the i-th type-C cue phrase is contained, the process goes to step. S604. If the i-th type-C cue phrase is not contained, the process goes to step S605.

(Step S604) The cited document information obtaining section 14 determines that the citation relationship of the cited document information is a “type C” citation relationship. The process returns to an upper-level function.

(Step S605) The cited document information obtaining section 14 increments the counter i by 1. The process returns to step S602.

(Step S606) The cited document information obtaining section 14 substitutes 1 into the counter i.

(Step S607) The cited document information obtaining section 14 determines whether or not an i-th type-B cue phrase is present. Note that it is here assumed that the cited document information obtaining section 14 holds a type-B cue phrase dictionary which contains a set of type-B cue phrases. Note that the type B citation relationship refers to a basis-of-theory type citation relationship in which one document proposes a new theory or construct a system based on the result of study in the other document. In the case of the basis-of-theory type citation relationship, the cue phrase includes phrases, such as “basis”, “to use a”, “We can”, “extended to”, and the like. If the i-th type-B cue phrase is present, the process goes to step S608. If the i-th type-B cue phrase is not present, the process goes to step S611.

(Step S608) The cited document information obtaining section 14 determines whether or not the i-th type-B cue phrase is contained in cited document information. If the i-th type-B cue phrase is contained, the process goes to step S609. If the i-th type-B cue phrase is not contained, the process goes to step S611.

(Step S609) The cited document information obtaining section 14 determines that the citation relationship of the cited document information is a “type B” citation relationship. The process returns to an upper-level function.

(Step S610) The cited document information obtaining section 14 increments the counter i by 1. The process returns to step S607.

(Step S611) The cited document information obtaining section 14 determines that the citation relationship of the cited document information is a “type 0” citation relationship. The process returns to an upper-level function. Note that the “type 0” citation relationship refers to a citation relationship which is neither a “type C” nor “type B” citation relationship.

Hereinafter, a specific operation of the information processing apparatus of this embodiment will be described.

Initially, a first specific example will be described. In this specific example, the document information storing section 11 of the information processing apparatus stores about 12,000 full-text papers (document information) in Postscript and PDF formats mainly in the field of natural language processing. Among them, about 8,000 papers are included in ACL Anthology provided by the ACL (the Association for Computational Linguistics), while the remaining about 4,000 papers are collected from Web sites of natural language processing researchers and natural language processing laboratories at home and abroad, paper data (document information) extracted from proceedings (CD-ROM) of international meetings, and the like. In other words, in this specific example, the document information storing section 11 stores a number of pieces of document information of a single type (paper data).

The document information obtaining section 13 obtains all pieces of document information having, in the titles thereof, term information received by the term information receiving section 12.

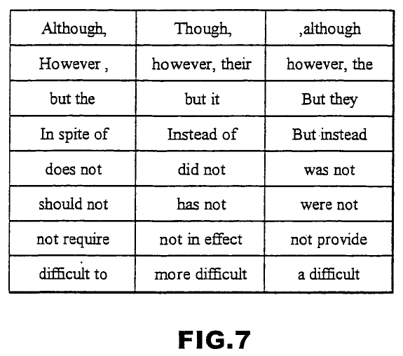

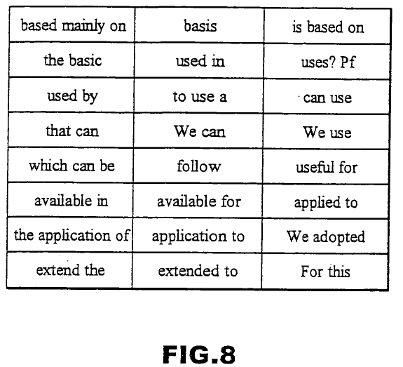

The cited document information obtaining section 14 holds a type-C cue phrase dictionary and a type-B cue phrase dictionary. FIG. 7 illustrates the type-C cue phrase dictionary, and FIG. 8 illustrates the type-B cue phrase dictionary. In this specific example, when a character string included in the type-C cue phrase dictionary is present in a portion in which a paper is cited, the cited document information obtaining section 14 determines that a citation relationship between the cited paper and a paper citing it is of the type C. Similarly, when a character string included in the type-B cue phrase dictionary is present in a portion in which a paper is cited, the cited document information obtaining section 14 determines that a citation relationship between the cited paper and a paper citing it is of the type B. In addition, the cited document information obtaining section 14 obtains the title of document information having the type-C or type-B citation relationship.

From the title of the document information obtained by the cited document information obtaining section 14, the related term information obtaining section 15 obtains related term information which is related to term information received by the term information receiving section 12.

In this situation, it is assumed that the user enters a term “terminology”.

Next, the term information receiving section 12 receives term information “terminology”.

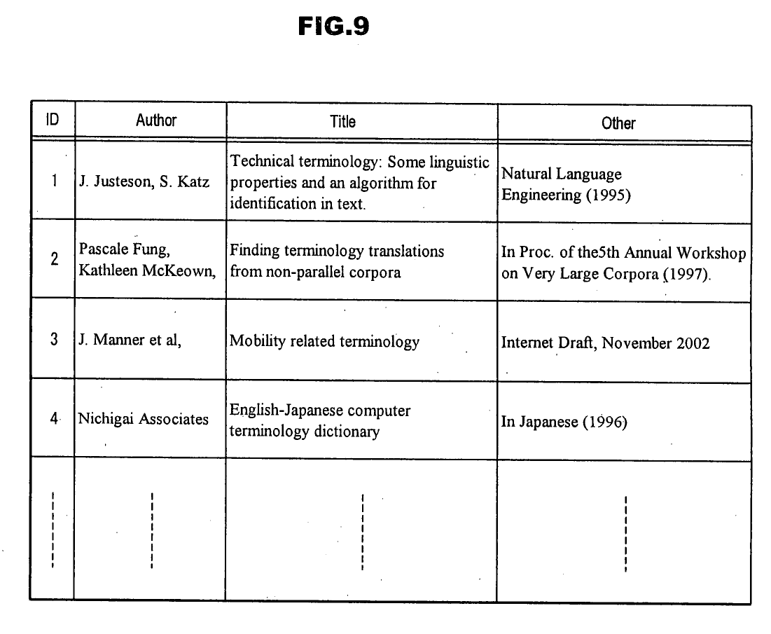

Next, the document information obtaining section 13 obtains a part (bibliography information) of document information which contains the term information “terminology” in the title thereof. The bibliography information thus obtained is illustrated in FIG. 9. The bibliography information of FIG. 9 is a record having “ID” “author”, “title”, and “other”. The “ID” is information for identifying a record and is used to manage records in a table. The “author” is an author (at least one person) of a paper. The “title” is a title of a paper. The “other” is information of the name of a paper journal, a published year, and the like.

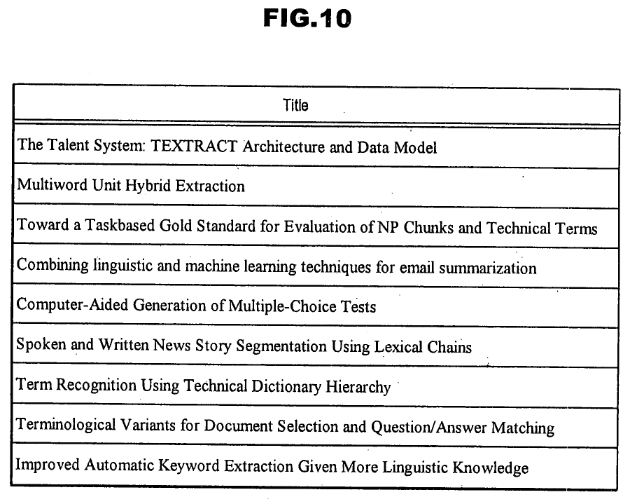

Next, the cited document information obtaining section 14 obtains first document information (a record having “ID=1” in FIG. 9) from the document information storing section 11. Thereafter, the cited document information obtaining section 14 obtains paper title(s) from a field of the first document information thus obtained which can be identified using a predetermined cue phrase (here, “Reference”). Papers indicated by the paper titles are cited papers. The titles of the cited papers thus obtained are illustrated in FIG. 10.

For all of the cited papers of FIG. 10, information of a citation portion is obtained using the original document information. For example, the cited document information obtaining section 14 obtains the citation portion information as follows. The cited document information obtaining section 14 extracts a sentence of a paper which. cites other paper(s) by finding a citation pattern in the paper (e.g., 1), (1), [1]). Next, the cited document information obtaining section 14 extracts a sentence which is significantly related to a sentence in which reference appears, using a cue word indicating a relation between sentences, such as “However”, “Furthermore”, or the like. Note that extraction of a citation portion is performed using the following cue words.
(1) Cues concerning anaphor: In this, On this, Such
(2) Cues concerning conjunction: But, However, Although
(3) Cues concerning first person: We, we, Our, our, us, I
(4) Cues concerning third person: They, they, Their, their, them
(5) Cues concerning adverb: Furthermore, Additionally, Still
(6) Other cues: In particular, follow, For example

The cited document information obtaining section 14 checks whether or not a term in the type-C cue phrase dictionary of FIG. 7 is present in the citation portion information. If a term in the type-C cue phrase dictionary is present, the cited document information obtaining section 14 determines that the citation relationship of this cited paper is of the “type C”.

If no terms in the type-C cue phrase dictionary are present, the cited document information obtaining section 14 checks whether or not a term in the type-B cue phrase dictionary of FIG. 8 is present in the citation portion information. If a term in the type-B cue phrase dictionary is present, the cited document information obtaining section 14 determines that the citation relationship of this cited paper is of the “type B”.

The cited document information obtaining section 14 determines that the citation relationship of other cited papers are of the “type 0”.

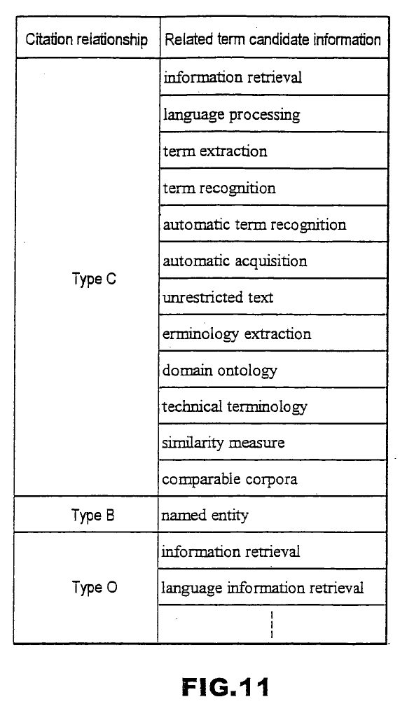

Thereafter, the related term information obtaining section 15 obtains a related term candidate information group of FIG. 11. The related term candidate information group of FIG. 11 has citation relationships and related term candidate information.

Next, the importance obtaining means 152 is assumed to calculate the importance of type-C and type-B related term candidate information of the related term candidate information group of FIG. 11. Also, the relevance calculating means 153 is assumed to calculate the relevance of the type-C and type-B related term candidate information of the related term candidate information group of FIG. 11. The related term information determining means 154 is assumed to thereafter multiply the importance and the relevance thus obtained to calculate an evaluation value. Note that the calculation of the importance and the calculation of the relevance can be performed by a known technique and will not be described in detail. Note that the importance and the relevance are calculated by any methods. The related term information obtaining section 15 may obtain related term information based only either the relevance or the importance. Alternatively, the related term information obtaining section 15 may obtain related term information without depending on the importance or the relevance. For example, the related term information obtaining section 15 may obtain all technical terms in the title of a cited document as related term information.

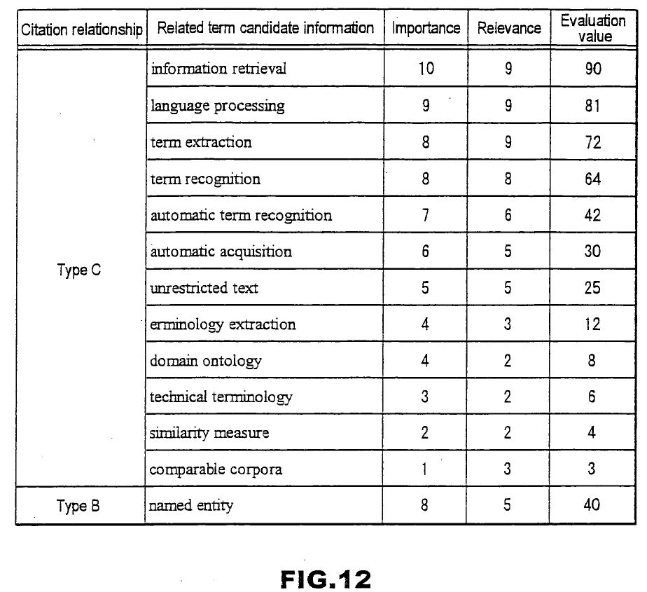

Thus, the related term information obtaining section 15 obtains information illustrated in FIG. 12. Note that FIG. 12 illustrates a table in which related term candidate information is sorted for each type using the evaluation value as a key.

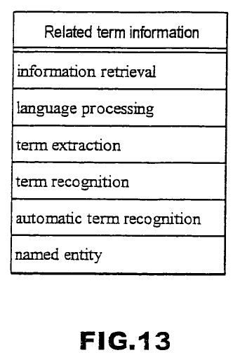

Next, for example, the related term information determining means 154 is assumed to regard related term candidate information having an evaluation value of 35 or more as related term information. In this case, the related term information determining means 154 obtains a related term information group illustrated in FIG. 13.

Next, the related term information outputting section 16 outputs the related term information of FIG. 13. Note that, in this information processing system, the related term information of FIG. 13 and the received term information may be accumulated or displayed on a display screen, in pairs. The display form is not particularly limited.

Next, a second specific example will be described. The document information storing section 11 of the information processing apparatus stores a number of academic papers and a number of patent documents. The academic papers include, for example, full-text papers, paper data (document information) extracted from proceedings (CD-ROM) of international meetings, and the like. The patent documents include, for example, patent specifications, patent claims, patent abstracts, and the like.

Also, the document information obtaining section 13 initially obtains all patent documents (document information) having the term information received by the term information receiving section 12 in the abstracts thereof.

The cited document information obtaining section 14 obtains identifiers (e.g., information for identifying a document, such as a patent number, a patent. publication number, an application number, a document name, and the like, etc.) of patent documents and non-patent documents described in the “Background Art” or “Prior Art” section in patent specifications of the patent documents. The identifiers of the patent documents and the non-patent documents are the identifiers of cited documents. When a cited document is a patent document, the cited document information obtaining section 14 obtains information of the abstract of the patent document. When a cited document is a non-patent document, the cited document information obtaining section 14 obtains the title of the non-patent document. Note that, when the cited document information obtaining section 14 cannot obtain document information identified by the identifier of a patent document or a non-patent document thus obtained, from the document information storing section 11, the cited document information obtaining section 14 ignores the identifier of the patent document or non-patent document. In other words, the cited document information obtaining section 14 does not obtain any information from the identifier of the patent document or non-patent document.

Next, the related term candidate information obtaining means 151 obtains information of a technical term from the information (information of an abstract or information of a title) obtained by the cited document information obtaining section 14. The technique of obtaining information of a technical term is known. The information of a technical term is related term candidate information.

Next, the importance obtaining means 152 calculates the importance of the related term candidate information thus obtained.

The relevance calculating means 153 calculates the relevance of the related term candidate information thus obtained.

Thereafter, the related term information determining means 154 uses the importance and the relevance as parameters to calculate an evaluation value. For example, the related term information determining means 154 calculates an evaluation value in accordance with “evaluation value =importance×relevance”.

When the evaluation value is larger than or equal to a predetermined value, the related term information determining means 154 determines that the related term candidate information is related term information.

With the above-described processes, the information processing apparatus obtains one or more pieces of related term information corresponding to the received term information.

Thereafter, the information processing apparatus outputs the related term information as described in the first specific example.

As described above, according to this embodiment, the citation relationship between documents can be used to extract related term(s) which are term(s) related to an input term. With this process, for example, a group of satisfactorily similar terms can be automatically collected. The term group can be utilized as a dictionary for language processing, information search, or the like.

Further, according to this embodiment, related term information is obtained by utilizing only document information having a specific type of citation relationship. Therefore, related term information can be obtained with considerably high precision.

Furthermore, according to this embodiment, related term information can be obtained by utilizing different types of document information, such as academic papers, patent documents, and the like. Therefore, considerably various related term information can be automatically collected.

Note that an embodiment of use of related term information automatically collected has not been described in this embodiment. The related term information automatically collected can be used as a concept dictionary. The related term information automatically collected can also be used in a search system as described in Embodiment 2. In addition, the related term information automatically collected can be used as various language processing systems.

According to the specific example of this embodiment, the different types of document information are academic papers and patent documents, i.e., two types. Alternatively, the document information storing section 11 may store three or more different types of document information. Examples of the three or more different types of document information include academic papers, patent documents, blogs, official journals, and the like.

Further, according to the specific example of this embodiment, related term information is obtained from cited document information having a type-B or type-C citation relationship. Alternatively, related term information may be obtained from cited document information having all citation relationships, or cited document information having only a type-B citation relationship. The method of obtaining a type is not particularly limited.

The process of this embodiment may be implemented by software. The software may be distributed by software downloading or the like. The software may be distributed in the form of a recording medium, such as a CD-ROM or the like, which stores it. Note that the same is applied to the other embodiments described herein. The software which implements the information processing apparatus of this embodiment is, for example, the following program. Specifically, this program is a program which causes a computer to execute: a term information receiving step of receiving term information which is information of a term; a document information obtaining step of obtaining the whole or a part of document information having the term information; a cited document information obtaining step of obtaining the whole or a part of cited document information which is information of a cited document having a citation relationship with a document corresponding to the document information, from the document information storing section, based on the whole or the part of the document information obtained by the document information obtaining step; a related term information obtaining step of obtaining related term information which is information of a related term which is related to the term indicated by the term information, based on the whole or the part of the cited document information obtained by the cited document information obtaining step; and a related term information outputting step of outputting the related term information obtained by the related term information obtaining step.

In the program, the related term information obtaining step may further comprise: a related term candidate information obtaining step of obtaining related term candidate information which is term information possessed by the whole or the part of the cited document information obtained by the cited document information obtaining step; a relevance calculating step of calculating the relevance between the related term candidate information and the term information received by the term information receiving section, based on the frequency of appearance of the related term candidate information in the whole or a part of one or more pieces of cited document information obtained by the cited document information obtaining step; and a related term information determining step of determining the related term candidate information as related term information based on the relevance.

Also in the program, the related term information obtaining step may further comprise an importance obtaining step of obtaining the importance of the related term candidate information obtained by the related term candidate information obtaining step. The relevance calculating step may calculate the relevance using only related term candidate information whose importance obtained by the importance obtaining step satisfies a predetermined condition.

Also in the program, in the cited document information obtaining step, it is preferable to obtain the whole or a part of cited document information of only a cited document(s) having a predetermined citation relationship with the document indicated by the document information.

Also in the program, it is preferable to obtain the whole or a part of cited document information of a cited document which has a citation relationship with a document corresponding to the document information and is of a type different from that of the document, in the cited document information obtaining step.

### EMBODIMENT 2

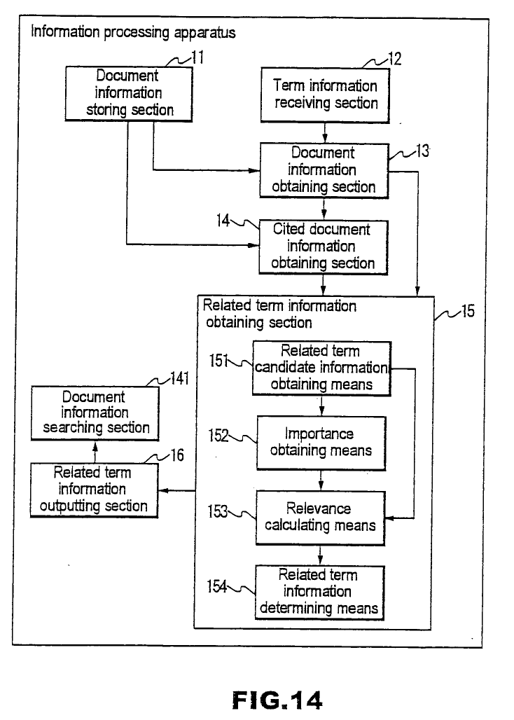

FIG. 14 is a block diagram illustrating an information processing apparatus according to Embodiment 2 of the present invention.

The information processing apparatus comprises a document information storing section 11, a term information receiving section 12, a document information obtaining section 13, a cited document information obtaining section 14, a related term information obtaining section 15, a related term information outputting section 16, and a document information searching section 141.

The document information searching section 141 searches for and outputs document information based on related term information output by the related term information outputting section 16. For example, the document information searching section 141 searches the document information storing section 11 for document information. Alternatively, the document information searching section 141 may search an external database or Web sites other than the document information storing section 11, for document information. The document information searching section 141 comprises a document information searching means for searching for document information based on related term information and a document information output means for outputting the document information. The document information searching section 141 may be a search engine which performs, for example, a keyword search based on one or more pieces of related term information. Note that the document information output by the document information searching section 141 may be a part, such as a title or the like. The document information searching section 141 may be typically implemented using an MPU, a memory, and the like. The process procedure of the document information searching section 141 is typically implemented by software, and the software is typically recorded in a recording medium, such as a ROM or the like. Note that the process procedure of the document information searching section 141 may be implemented by hardware (dedicated circuit).

Note that, here, the related term information outputting section 16 transfers related term information obtained by the related term information obtaining section 15 to the document information searching section 141.

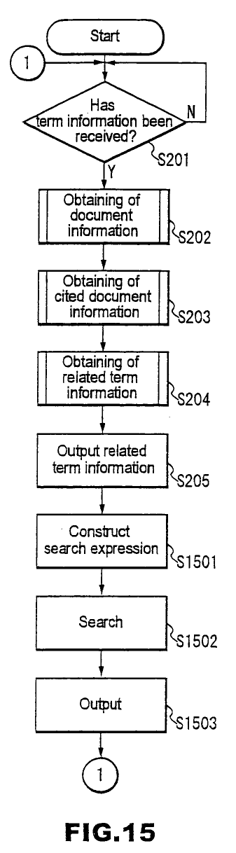

Next, an operation of the information processing apparatus will be described with reference to a flowchart illustrated in FIG. 15. In the flowchart of FIG. 15, the same steps as those in the flowchart of FIG. 2 will not be described.

(Step S1501) The document information searching section 141 constructs a search expression based on the related term information output by the related term information outputting section 16. Preferably, the document information searching section 141 constructs a search expression based on the related term information output by the related term information outputting section 16 and term information received by the term information receiving section 12. For example, the document information searching section 141 constructs a search expression (e.g., SQL, etc.) which allows a search for document information containing, in the abstract thereof, a term indicated by any of the term information and one or more pieces of related term information.

(Step S1502) The document information searching section 141 searches for document information based on the search expression constructed in step S1501.

(Step S1503) The document information searching section 141 outputs the document information retrieved in step S1502. Note that the output document information may be a part (e.g., a title, etc.) of the document information.

Note that the process is ended by powering off or interruption for aborting the process in the flowchart of FIG. 15.

As described above, according to this embodiment, the information processing apparatus obtains one or more pieces of related term information corresponding to received term information, and can perform an information search using the related term information.

Note that software which implements the information processing apparatus of this embodiment is, for example, the following program. Specifically, this program is a program which causes a computer to execute: a term information receiving step of receiving term information which is information of a term; a document information obtaining step of obtaining the whole or a part of document information having the term information; a cited document information obtaining step of obtaining the whole or a part of cited document information which is information of a cited document having a citation relationship with a document corresponding to the document information, from the document information storing section, based on the whole or the part of the document information obtained by the document information obtaining step; a related term information obtaining step of obtaining related term information which is information of a related term which is related to the term indicated by the term information, based on the whole or the part of the cited document information obtained by the cited document information obtaining step; a related term information outputting step of outputting the related term information obtained by the related term information obtaining step; and a document information searching step of searching for and outputting document information based on the related term information output by the related term information outputting step.

### EMBODIMENT 3

An information processing system according to Embodiment 3 of the present invention will be described, in which one or more pieces of related term information corresponding to term information are obtained using a server-client system.

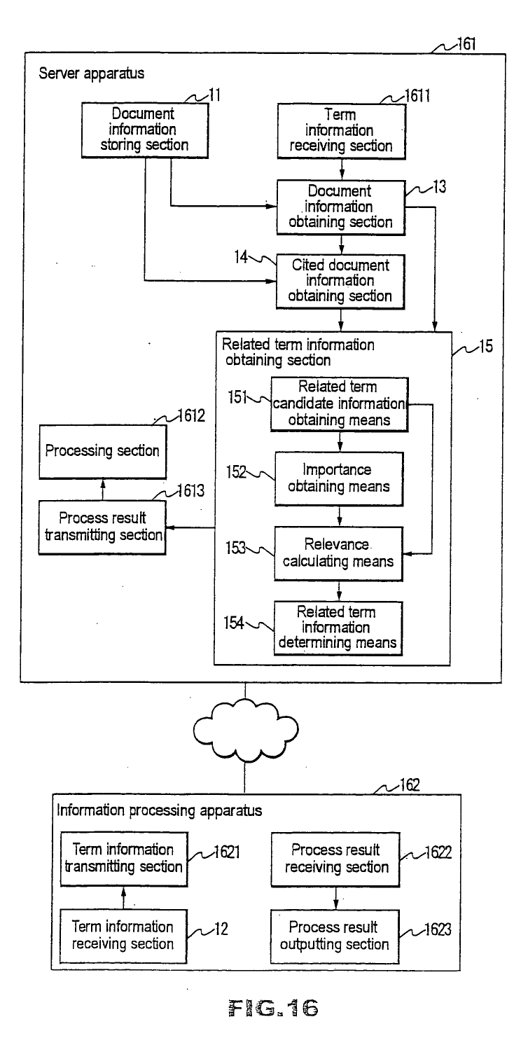

FIG. 16 is a block diagram illustrating the information processing system of this embodiment.

The information processing system comprises a server apparatus 161 and an information processing apparatus 162.

The server apparatus 161 comprises a document information storing section 11, a term information receiving section 1611, a document information obtaining section 13, a cited document information obtaining section 14, a related term information obtaining section 15, a processing section 1612, and a processing result transmitting section 1613.

The information processing apparatus 162 comprises a term information receiving section 12, a term information transmitting section 1621, a processing result receiving section 1622, and a processing result outputting section 1623.

The term information receiving section 1611 receives term information which is information of a term from the information processing apparatus 162. The term information receiving section 1611 is typically implemented by wireless or wired communications means, or alternatively, may be implemented by broadcast receiving means.

The processing section 1612 performs a process based on the related term information obtained by the related term information obtaining section 15. The process is, for example, a process of searching for document information. The process may also be, for example, a process of constructing related term information to be transmitted. The processing section 1612 may be typically implemented using an MPU, a memory, and the like. The process procedure of the processing section 1612 is typically implemented by software, and the software is typically recorded in a recording medium, such as a ROM or the like. Note that the process procedure of the processing section 1612 may be implemented by hardware (dedicated circuit).

The processing result transmitting section 1613 transmits a result of the process in the processing section 1612 to the information processing apparatus 162. When the process is a document information searching process, the process result is, for example, retrieved document information. When the process is a process of constructing related term information to be transmitted, the process result is, for example, related term information in a transmission format. The processing result transmitting section 1613 is typically implemented by wireless or wired communication means, or alternatively, may be implemented by broadcasting means.

The term information transmitting section 1621 transmits the term information received by the term information receiving section 12 to the server apparatus 161. The term information transmitting section 1621 is typically implemented by wireless or wired communication means, or alternatively, may be implemented by broadcasting means.

The processing result receiving section 1622 receives the process result, corresponding to transmission of the term information. The processing result receiving section 1622 is typically implemented by wireless or wired communication means, or alternatively, may be implemented by means for receiving broadcast.

The processing result outputting section 1623 outputs the process result received by the processing result receiving section 1622. Here, the term “output” is a concept including displaying on a display screen, accumulation into a recording medium, printing in a printer, outputting a sound, transmission to an external apparatus, and the like. The processing result outputting section 1623 may or may not include an output device, such as a display, a loudspeaker, or the like. The processing result outputting section 1623 may be implemented as driver software for an output device, a combination of driver software for an output device and the output device, or the like.

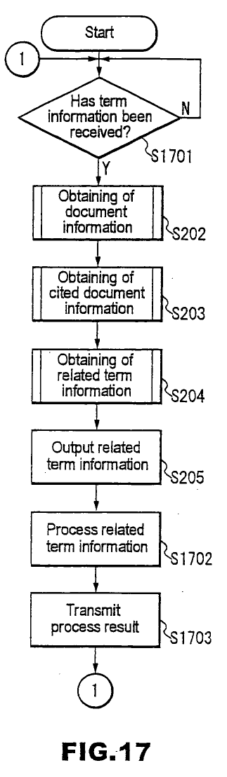

Next, an operation of the information processing system will be described. Firstly, an operation of the server apparatus 161 will be described with reference to a flowchart illustrated in FIG. 17. In the flowchart of FIG. 17, the same steps as those of the flowchart of FIG. 2 will not be described.

(Step S1701) The term information receiving section 1611 determines whether or not it has received term information. If term information has been received, the process goes to step S202. If term information has not been received, the process returns to step S1701.

(Step S1702) The processing section 1612 performs a process based on the related term information obtained by the related term information obtaining section 15.

(Step S1703) The processing result transmitting section 1613 transmits a result of the process in step S1702 to the information processing apparatus 162.

Note that, in the flowchart: of FIG. 17, the process is ended by powering off or interruption for aborting the process Next, an operation of the information processing apparatus 162 will be described.

Initially, the term information receiving section 12 of the information processing apparatus 162 receives term information. Next, the term information transmitting section 1621 transmits the term information to the server apparatus 161. Next, the processing result receiving section 1622 waits until it receives the process result from the server apparatus 161. When the processing result receiving section 1622 receives the process result, the processing result outputting section 1623 outputs the process result.

As described above, according to this embodiment, even in the server-client system, it is possible to provide a system capable of obtaining one or more pieces of related term information corresponding to term information and utilizing the related term information.

Note that, according to this embodiment, the process performed in the processing section 1612 based on related term information may include various processes in addition to a search process. For example, the process is a process of constructing a synonym dictionary from related term information and term information.

Although the processing result transmitting section 1613 transmits the process result of the processing section 1612 to the information processing apparatus 162 in this embodiment, the processing result transmitting section 1613 may not transmit it. In this case, the process result is not transmitted to the information processing apparatus 162 and is accumulated in the server apparatus 161. It is preferable that the process result be utilized from the information processing apparatus 162 as required.

The process of this embodiment may be implemented by software. The software may be distributed by software downloading or the like. The software may be distributed in the form of a recording medium, such as a CD-ROM or the like, which stores it. Note that the same is applied to the other embodiments described herein. The software which implements the server apparatus of this embodiment is, for example, the following program. Specifically, this program is a program which causes a computer to execute: a term information receiving step of receiving term information which is information of a term; a document information obtaining step of obtaining the whole or a part of document information having the term information; a cited document information obtaining step of obtaining the whole or a part of cited document information which is information of a cited document having a citation relationship with a document corresponding to the document information, from the document information storing section, based on the whole or the part of the document information obtained by the document information obtaining step; a related term information obtaining step of obtaining related term information which is information of a related term which is related to the term indicated by the term information, based on the whole or the part of the cited document information obtained by the cited document information obtaining step; a processing step of performing a process based on the related term information obtained by the related term information obtaining step; and a process result transmitting step of transmitting a result of the process in the processing step.

In each of the above-described embodiments, each process (each function) may be carried out by centralized processing using a single apparatus (system), or alternatively, may be carried out by distributed processing using a plurality of apparatuses.

Note that, in the above-described program, the step of transmitting information, the step of receiving information, and the like do not include a process performed by hardware, such as a process in the transmission step performed in a modem, an interface card, or the like (a process performed only by hardware), or the like.

The program may be executed by a single or a plurality of computers. In other words, the program may be performed by either centralized processing or distributed processing.

As described above, the information processing apparatus of the present invention has an effect such that the precision of related term collection is high, and is useful as, for example, an information processing apparatus which collects related terms corresponding to an input term.

The present invention is not limited to the embodiments set forth herein. Various modifications are possible within the scope of the present invention.

1. An information processing apparatus comprising:
a document information storing section for storing one or more pieces of document information which is information of a document;
a term information receiving section for receiving term information which is information of a term;
a document information obtaining section for obtaining the whole or a part of document information having the term information;
a cited document information obtaining section for obtaining the whole or a part of cited document information which is information of a cited document having a citation relationship with a document corresponding to the document information, from the document information storing section, based on the whole or the part of the document information obtained by the document information obtaining section;
a related term information obtaining section for obtaining related term information which is information of a related term which is related to the term indicated by the term information, based on the whole or the part of the cited document information obtained by the cited document information obtaining section; and
a related term information outputting section for outputting the related term information obtained by the related term information obtaining section.

2. The information processing apparatus according to claim 1, wherein the related term information obtaining section comprises:
related term candidate information obtaining means for obtaining related term candidate information which is term information possessed by the whole or the part of the cited document information obtained by the cited document information obtaining section;
relevance calculating means for calculating a relevance between the related term candidate information and the term information received by the term information receiving section, based on a frequency of appearance of the related term candidate information in the whole or a part of one or more pieces of cited document information obtained by the cited document information obtaining section; and
related term information determining means for determining the related term candidate information as related term information based on the relevance.

3. The information processing apparatus according to claim 2, wherein the related term information obtaining section further comprises:
importance obtaining means for obtaining an importance of the related term candidate information obtained by the related term candidate information obtaining means,
wherein the relevance calculating means calculates the relevance with respect to only related term candidate information whose importance obtained by the importance obtaining means satisfies a predetermined condition.

4. The information processing apparatus according to claim 1, wherein the cited document information obtaining section obtains the whole or a part of cited document information of only a cited document having a predetermined citation relationship with a document indicated by the document information, from the document information storing section.

5. The information processing apparatus according to claim 1, wherein the document information storing section stores two or more types of document information, and
the cited document information obtaining section obtains the whole or a part of cited document information of a cited document which has a citation relationship with a document corresponding to the document information and is of a type different from that of the document, from the document information storing section.

6. The information processing apparatus according to claim 5, wherein the type of the document is academic paper and the type of the cited document is patent document, or the type of the document is patent document and the type of the cited document is academic paper.

7. The information processing apparatus according to claim 1, further comprising a document information searching section for searching for and outputting document information based on the related term information output by the related term information outputting section.

8. An information processing system comprising a server apparatus and an information processing apparatus, wherein the server apparatus comprises:
a document information storing section for storing one or more pieces of document information which is information of a document;
a term information receiving section for receiving term information which is information of a term from the information processing apparatus;
a document information obtaining section for obtaining the whole or a part of document information having the term information;
a cited document information obtaining section for obtaining the whole or a part of cited document information which is information of a cited document having a citation relationship with a document corresponding to the document information, from the document information storing section, based on the whole or the part of the document information obtained by the document information obtaining section;
a related term information obtaining section for obtaining related term information which is information of a related term which is related to the term indicated by the term information, based on the whole or the part of the cited document information obtained by the cited document information obtaining section;
a processing section for performing a process based on the related term information obtained by the related term information obtaining section; and
a process result transmitting section for transmitting a result of the process in the processing section to the information processing apparatus, and the information processing apparatus comprises:
a term information receiving section for receiving term information;
a term information transmitting section for transmitting the term information to the server apparatus;
a process result receiving section for receiving the process result, corresponding to the transmission of the term information; and
a process result outputting section for outputting the process result received by the process result receiving section.

9. The information processing system according to claim 8, wherein the related term information obtaining section comprises:
related term candidate information obtaining means for obtaining related term candidate information which is term information possessed by the whole or the part of the cited document information obtained by the cited document information obtaining section;
relevance calculating means for calculating a relevance between the related term candidate information and the term information received by the term information receiving section, based on a frequency of appearance of the related term candidate information in the whole or a part of one or more pieces of cited document information obtained by the cited document information obtaining section; and
related term information determining means for determining the related term candidate information as related term information based on the relevance.

10. The information processing system according to claim 9, wherein the related term information obtaining section further comprises:
importance obtaining means for obtaining an importance of the related term candidate information obtained by the related term candidate information obtaining means,
wherein the relevance calculating means calculates the relevance with respect to only related term candidate information whose importance obtained by the importance obtaining means satisfies a predetermined condition.

11. The information processing system according to claim 8, wherein the cited document information obtaining section obtains the whole or a part of cited document information of only a cited document having a predetermined citation relationship with a document indicated by the document information, from the document information storing section.

12. The information processing system according to claim 8, wherein the document information storing section stores two or more types of document information, and
the cited document information obtaining section obtains the whole or a part of cited document information of a cited document which has a citation relationship with a document corresponding to the document information and is of a type different from that of the document, from the document information storing section.

13. The information processing system according to claim 12, wherein the type of the document is academic paper and the type of the cited document is patent document, or the type of the document is patent document and the type of the cited document is academic paper.

14. A server apparatus constituting the information processing system according to claim 8.

15. A program which causes a computer to execute:
a term information receiving step of receiving term information which is information of a term;
a document information obtaining step of obtaining the whole or a part of document information having the term information;
a cited document information obtaining step of obtaining the whole or a part of cited document information which is information of a cited document having a citation relationship with a document corresponding to the document information, from a document information storing section, based on the whole or the part of the document information obtained by the document information obtaining step;
a related term information obtaining step of obtaining related term information which is information of a related term which is related to the term indicated by the term information, based on the whole or the part of the cited document information obtained by the cited document information obtaining step; and
a related term information outputting step of outputting the related term information obtained by the related term information obtaining step.

16. The program according to claim 15, wherein the cited document information obtaining step obtains the whole or a part of cited document information of only a cited document having a predetermined citation relationship with a document indicated by the document information.

17. The program according to claim 15, wherein the cited document information obtaining step obtains the whole or a part of cited document information of a cited document which has a citation relationship with a document corresponding to the document information and is of a type different from that of the document.

18. The program according to claim 15, further causing the computer to execute a document information searching step of searching for and outputting document information based on the related term information output by the related term information outputting step.

19. A program which causes a computer to execute:
a term information receiving step of receiving term information which is information of a term;
a document information obtaining step of obtaining the whole or a part of document information having the term information;
a cited document information obtaining step of obtaining the whole or a part of cited document information which is information of a cited document having a citation relationship with a document corresponding to the document information, from a document information storing section, based on the whole or the part of the document information obtained by the document information obtaining step;
a related term information obtaining step of obtaining related term information which is information of a related term which is related to the term indicated by the term information, based on the whole or the part of the cited document information obtained by the cited document information obtaining step;
a processing step of performing a process based on the related term information obtained by the related term information obtaining step; and
a process result transmitting step of transmitting a result of the process in the processing step.
